(19) United States
(12) Patent Application Publication
(10) Pub. No.: US 2010/0092837 A1
(43) Pub. Date: Apr. 15, 2010

(54) PLATE-LAMINATED TYPE FUEL CELL

(76) Inventors: Taner Akbay, Ibaraki (JP); Takashi Miyazawa, Ibaraki (JP); Naoya Murakami, Ibaraki (JP); Tadahiko Suzuki, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/529,790

(22) PCT Filed: Mar. 4, 2008
(86) PCT No.: PCT/JP2008/000434

§ 371 Date: Sep. 3, 2009

(30) Foreign Application Priority Data
Mar. 6, 2007 (JP) 2007-055850

(51) Int. Cl. H01M 8/24; H01M 2/00

(52) U.S. Cl. 429/34

(57) ABSTRACT

The objective of the invention is to prevent plastic deformation of separators in a heat cycle of the fuel cell, to thereby prevent damage to the power generation cell. A laminated body is formed by alternately laminating power generation cells (5) and separators (8) having reactant gas passages (11 and 12) inside thereof, and a fuel gas manifold and an oxidant gas manifold, which are in communication with the reactant gas passages (11 and 12) of each separator (8) and extending in the laminating direction, are located at a periphery of the laminated body, and a load is applied to the laminated body in the laminating direction. The separator (8) includes: an interconnect section (8a) at a center of which the power generation cell (5) is located; and a pair of arm sections (8b) with an elongated strip shape, each arm section (8b) extending from a rim of the interconnect section (8a), and an end (8c) of each arm section (8b) being connected to the fuel gas manifold or the oxidant gas manifold. The arm section (8b) has flexibility so that it can be deformed in the laminating direction, and the deformation of the arm section (8b) is kept in the range of elastic deformation during the heat cycle.

### TECHNICAL FIELD

The present invention relates to a plate-laminated type fuel cell constructed by alternately laminating power generation cells and separators, and more particularly to a structure of the separator.

### BACKGROUND ART

A plate-laminated type fuel cell is known in the art, which is constructed by alternately laminating separators and power generation cells having a structure in which a solid electrolyte layer made of an oxide ion conductor is sandwiched between an air electrode layer and a fuel electrode layer.

The plate-laminated type fuel cell has a multilayered structure in which each of the power generation cells is formed by laminating a plurality of fuel elements described above, and these power generation cells are also laminated through the separators and conductive members such as current collectors. Therefore, the plate-laminated type fuel cell is required to have excellent adhesiveness between elements thereof for securing stable fuel cell performance. Thus, the plate-laminated type fuel cell adopts a structure in which the elements are pressure bonded by arranging plates at the top and bottom ends of a stack (laminated body) and tightening the plates with bolts and nuts to thereby apply a compression load to the stack in the laminating direction, for example.

However, especially in case of the plate-laminated type fuel cell having an internal manifolds, laminated elements in the power generating section located at the center of the stack are different from those in the manifold section located at the peripheral of the stack. Besides, when the manifold section and the power generating section are clamped from the top and bottom of the stack with the use of the stacking plates, the peripheral portion and the center portion are clamped by the separator plates with high stiffness such that displacement in the peripheral portion is the same as that in the center portion. As a result, clamping force in each section is deficient due to difference in height between the sections, resulting in problems that adhesiveness between the elements is deteriorated, and the power generation cells are damaged by excess clamping force applied on the power generating section.

In view of the problems described above, the applicants of the present invention have proposed a structure of the separator which enables both the manifold section and the power generating section to be clamped by a preferred load, in Patent Document 1.

As shown in FIG. 4, Patent Document 1 shown below discloses a separator 8 having a structure in which a pair of arm sections 8b having an elongated strip shape protrude from the rim of an interconnect section 8a at the center of which a power generation cell 5 is located, and tip ends (manifold sections 8c) of the arm sections 8b are fixed to the fuel gas manifold and the oxidant gas manifold located at the peripheral portion of the laminated body, respectively.

According to the separator 8 described above, the arm sections 8b have suitable flexibility so that it can be displaced in the laminating direction, therefore, the load applied to the separator 8 can be dispersed into both the manifold section 8c and the interconnect section 8a. Thus, variation in height between the manifold section 8c and the interconnect section 8a can be absorbed and the sections can be tightened up with optimal load.

However, the separator shown in FIG. 4 has structural problems as described below.

Under high temperature condition at the time of power generation, when the height of the stack is decreased along with the thickness decrease of the current collectors due to creep deformation under load at high temperature, the arm sections 8b of the separator 8 are deformed, and then, the interconnect section 8a is displaced to the position lower than the manifold section 8c. In case of the structure shown in FIG. 4, the manifold sections 8c are positioned at the opposite corners of the square separator, and the arm sections 8b extend from the middle portion of the upper or lower side of the square separator, therefore, it is difficult to ensure sufficient length of the arm sections 8b and, as a result, huge deformation which reaches the range of plastic deformation occurs in the arm sections 8b.

In FIG. 4, the vicinity of the manifold section 8c denoted by symbol “r1” is a region where large plastic deformation due to bending occurs, and the vicinity of the extended portion 8d which is extending from the interconnect section 8a and denoted by symbol “r2” is a region where large plastic deformation under torsion occurs.

When plastic deformation occurs in the arm sections 8b at the time of power generation as described above, undesirably large force is applied to the power generation cells 5 through the arm sections 8b which are deformed in the shrinking process of the whole stack due to decrease in temperature during falling temperature, and thus, the power generation cells 5 may be damaged by the force. Further, when the interconnect section 8a is deformed due to bending or torsion of the arm sections 8b, uneven stress occurs in the power generation cell 5, whereby the power generation cell 5 may be damaged by the stress.

Patent document 1: Japanese Patent Laid-Open No. 2006-120589

### DISCLOSURE OF THE INVENTION

The object of the present invention is to provide a plate-laminated-type fuel cell which can prevent plastic deformation of separators in a heat cycle of the fuel cell, to thereby prevent damage to the power generation cell.

A flat plate laminated type fuel cell according to the present invention comprises: a laminated body constructed by alternately laminating power generation cells and separators, each separator having a reactant gas passage inside thereof; and a fuel gas manifold and an oxidant gas manifold located at a periphery of the laminated body, each manifold being in communication with the reactant gas passage of each separator and extending in the laminating direction, wherein a load is applied to the laminated body in the laminating direction. Each of the separators includes: an interconnect section at a center of which the power generation cell is located; and a pair of arm sections of an elongated strip shape, each arm section extending from a rim of the interconnect section, and an end of one arm section being connected to the fuel gas manifold and an end of the other arm section being connected to the oxidant manifold, wherein each arm section has flexibility so that it can be deformed in the laminating direction, and the deformation of the arm section is kept in the range of elastic deformation during a heat cycle from startup to shutdown through power generating operation.

The plate-laminated type fuel cell described above may have a structure in which the fuel and oxidant gas manifolds are located at opposite corners (a pair of diagonally opposite corners) of the laminated body having square column shape, and each arm section has a proximal portion, extending from the interconnect section, located at diagonal position of a distal end of the corresponding arm section.

Further, the plate-laminated type fuel cell described above may have a structure in which corners of the arm sections are made round.

According to the present invention, since the elastic deformation of the arm section of the separator is kept in the range of elastic deformation under high temperature atmosphere at the time of power generation, undesirable stress which is likely to occur in the power generation cells due to plastic deformation of the arm sections in the process of falling temperature can be minimized and, accordingly damage to the power generation cell can be prevented.

In particular, since the proximal portion of the arm section is located at diagonal position of the distal end of the arm section, it is possible to ensure sufficient length of the arm section. Thus, local deformation of the arm section under load at high temperature can be reduced, whereby the deformation of the arm section can be kept in the range of elastic deformation.

In addition, since the proximal portion of the arm section is located at diagonal position of the distal end of the arm section, distance between the interconnect section and the proximal portion of the arm section can be increased as much as possible. Therefore, the effect of the deformation force of the arm sections on the interconnect section can be minimized, and flatness of the interconnect section can be maintained. As a result, uneven load applied to the power generation cell can be prevented, and damage to the power generation cell can be prevented.

Further, since the corners of the arm sections are rounded to eliminate structural discontinuity, concentration of stress at the corners of the arm sections can be reduced, and local plastic deformation of the arm sections can be suppressed. Accordingly, the deformation of the arm section can be kept in the range of elastic deformation, and damage to the power generation cell can be prevented.

### BRIEF DESCRIPTION OF THE DRAWINGS

FIG. 1 is a view showing a configuration of a plate-laminated type solid oxide fuel cell according to the present invention;

FIG. 2 is an enlarged view of a part of the solid oxide fuel cell shown in FIG. 1;

FIG. 3 is a view showing a structure of a separator shown in FIG. 1; and

FIG. 4 is a view showing a configuration of a conventional separator.

### DESCRIPTION OF THE REFERENCE NUMERALS

1 Plate-type fuel cell

(Plate-laminated type solid oxide fuel cell)

5 Power generation cell

8 Separator

8a Interconnect section

8b Arm section

8d Proximal portion

8c Distal end (Manifold section)

17 Fuel gas manifold

18 Oxidant gas manifold

### BEST MODE FOR CARRYING OUT THE INVENTION

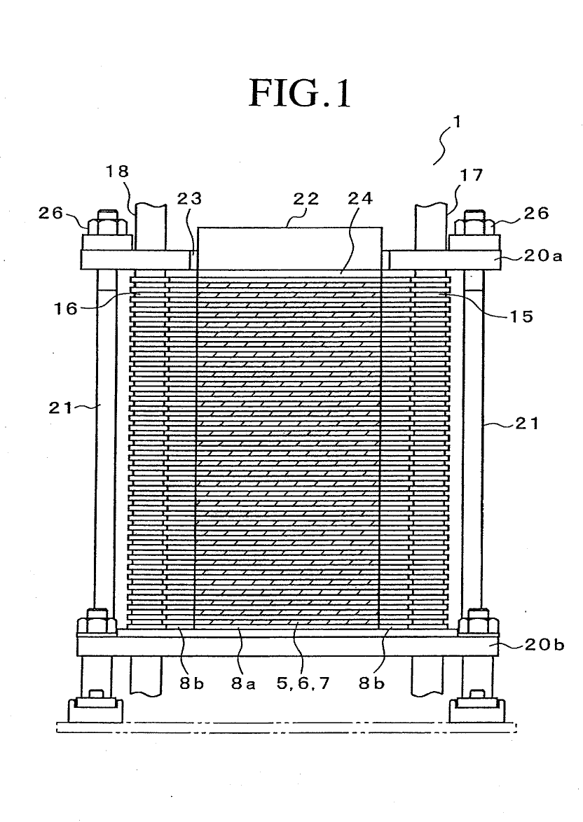

An embodiment of a solid oxide fuel cell according to the present invention will be described below with reference to FIGS. 1-3.

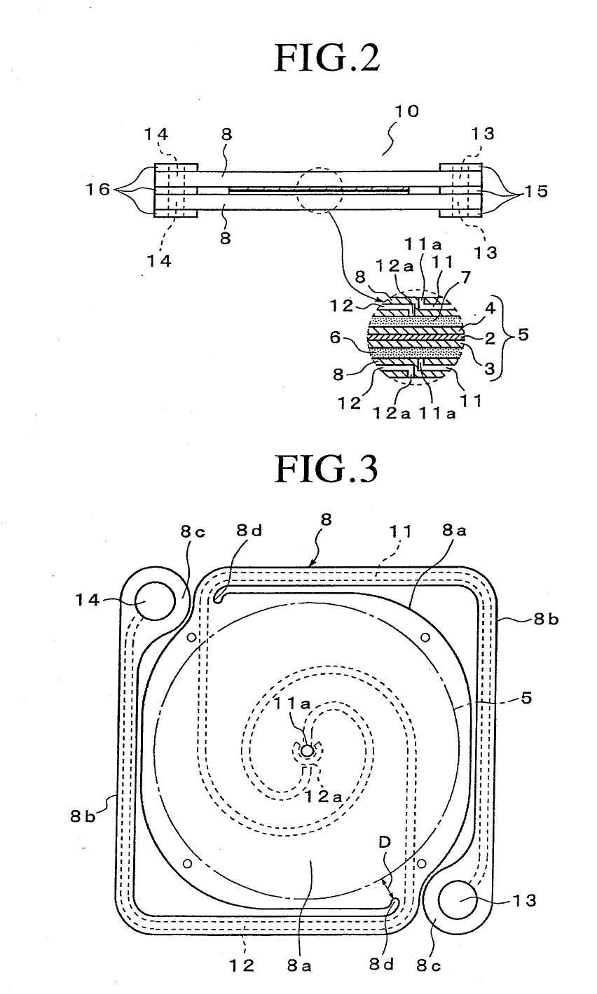

FIG. 1 shows a configuration of a plate-laminated type solid oxide fuel cell 1 (fuel cell stack 1) according to the present invention; FIG. 2 shows an enlarged view of a part of FIG. 1; and FIG. 3 shows a structure of a separator 8.

As shown in FIG. 2, a stack unit 10 comprises a circular power generation cell 5 in which a fuel electrode layer 3 and an air electrode layer 4 are arranged on both surfaces of a solid electrolyte layer 2, a fuel electrode current collector 6 on the outer side of the fuel electrode layer 3, an air electrode current collector 7 on the outer side of the air electrode layer 4, and two separators 8 on the outer side of each of the current collectors 6 and 7.

Among power generating elements mentioned above, the solid electrolyte layer 2 is formed of stabilized zirconia (YSZ) doped with yttria, and the like. The fuel electrode layer 3 is formed of a metal such as Ni, or a cermet such as Ni-YSZ. The air electrode layer 4 is formed of LaMnO₃, LaCoO₃ and the like. The fuel electrode current collector 6 is formed of a sponge-like porous sintered metallic plate such as Ni, and the air electrode current collector 7 is formed of a sponge-like porous sintered metallic plate such as Ag.

The separator 8 is formed of an almost-square stainless steel plate having a thickness of several millimeters, as shown in FIG. 3. The separator 8 includes: an interconnect section 8a, positioned at the center of the separator 8, on which the power generation cell 5 and the current collectors 6 and 7 are laminated; and a pair of arm sections 8b and 8b, extending from the interconnect section 8a in the planar direction, for supporting the rim of the interconnect section 8a at two diagonally opposite points. The interconnect section 8a positioned at the center of the separator 8 has a function of electrically connecting the power generation cells 5 through the current collectors 6 and 7 and of supplying reactant gases (oxidant gas and fuel gas) to the power generation cell 5. Within the interior of the separator 8, an oxidant gas passage 12 and a fuel gas passage 11 are formed.

The ends 8c and 8c (manifold sections 8c and 8c) of the respective arm sections 8b and 8b are positioned at the opposite corners of the square separator 8, and in the arm section 8b, each portion extending from the interconnect section 8a (hereinafter referred as a proximal portion 8d) is located at diagonal position of the corresponding manifold section 8c. That is, each of the arm sections 8b extends vertically from the corresponding manifold section 8c, and curves in a horizontal direction at the middle of the arm section 8b, and extends to the proximal portion 8b positioned diagonally opposite to the corresponding manifold section 8c.

Each of the arm sections 8b and 8b has an elongated strip shape to have flexibility so that it can be deformed in the laminating direction. The arm section 8b as a whole is rounded to eliminate structural discontinuity, that is, discontinuous corners. There is a narrow gap between the arm section 8b and the interconnect section 8a.

Each end 8c of the arm section 8b, namely, each manifold section 8c, has an oxidant gas hole 14 or a fuel gas hole 13 which penetrates through the separator 8 in the thickness direction. The oxidant gas hole 14 is in communication with the oxidant gas passage 12 of the separator 8 via one arm section 8b, and the fuel gas hole 13 is in communication with the fuel gas passage 11 via the other arm section 8b. Oxidant gas and fuel gas are supplied from the gas holes 14 and 13 through the gas passages 12 and 11 to gas outlets 12a and 11a, which are terminals of the gas passages 12 and 11, and discharged from the gas outlets 12a and 11a toward center portions of electrode surfaces (air electrode layer 4 and fuel electrode layer 3) of the power generation cell 5.

As shown in FIGS. 1 and 2, the stack units 10 having the structure described above are laminated in order through ring-shaped insulating gaskets 15 and 16 to form a laminated body. Square top and bottom clamping plates 20a and 20b which are larger than the separator 8 in size are arranged at the top and bottom ends of the laminated body, and the rims of the plates 20a and 20b are clamped with bolts 21 and nuts 26 at four points. By the clamp load, the gaskets 16 and 15 are connected in the laminating direction through the corresponding gas holes 14 and 13 of the separator 8, and internal manifolds (an oxidant gas manifold 18 and a fuel gas manifold 17) extending in the laminating direction and positioned at the opposite corners of the stack are formed.

In addition, a circular hole 23 having inner diameter larger than outer diameter of the power generation cell 5 is formed at the center of the top clamping plate 20a, and the interconnect section 8a of the separator 8, namely, an area where the power generation cell 5 is arranged, is exposed through the circular hole 23.

In this embodiment, a weight 22 is loaded through an insulating member 24 at a portion where the circular hole 23 of the top clamping plate 20a is formed. As a result, the interconnect sections 8a of the separator 8 are pressed by the load of the weight 22 in the laminating direction (the load is set at 3 kgf at the top end of the stack, and 30 kgf at the bottom end), whereby a plurality of power generating elements of the stack unit 10 are adhered firmly to each other and fixed integrally.

Since the fuel electrode current collector 6 and the air electrode current collector 7 interposed between the power generation cell 5 and the separator 8 are formed of sponge-like porous sintered metallic plates, they are slightly collapsed when the weight 22 is loaded on the fuel cell stack 1. Thus, in this situation, the interconnect section 8a of the separator 8 is displaced to the position (approx. 2-3 mm) lower than the manifold sections 8c of the arm sections 8b in a vertical direction, and the arm sections 8b having elongated strip shape are curved obliquely downward.

At the time of operation (power generation), oxidant gas (air) and fuel gas externally supplied to the oxidant gas manifold 18 and the fuel gas manifold 17 flow, and these reactant gases are distributed and introduced to the air electrode layer 4 and the fuel electrode layer 3 of the respective power generation cells 5 from the oxidant gas hole 14 and the fuel gas hole 13 of the separator 8 through the oxidant gas passage 12 and the fuel gas passage 11, to thereby cause a power generating reaction in the respective power generation cells 5. It is noted that the temperature in the fuel cell stack 1 at the time of power generation is set at approx. 600 to 800 ° C.

As described above, according to the present embodiment, the stack unit 10 has a structure in which an optimal load is applied to the manifold sections 8a and the interconnect section 8c of the separator 8 with no influence on the other sections, by providing the arm sections 8b of the separator 8 with flexibility. Consequently, it is possible to have an excellent electrical contact properties between the power generating elements, and improve gas seal performance in the manifold sections 8c. As a result, power generating performance and efficiency can be improved.

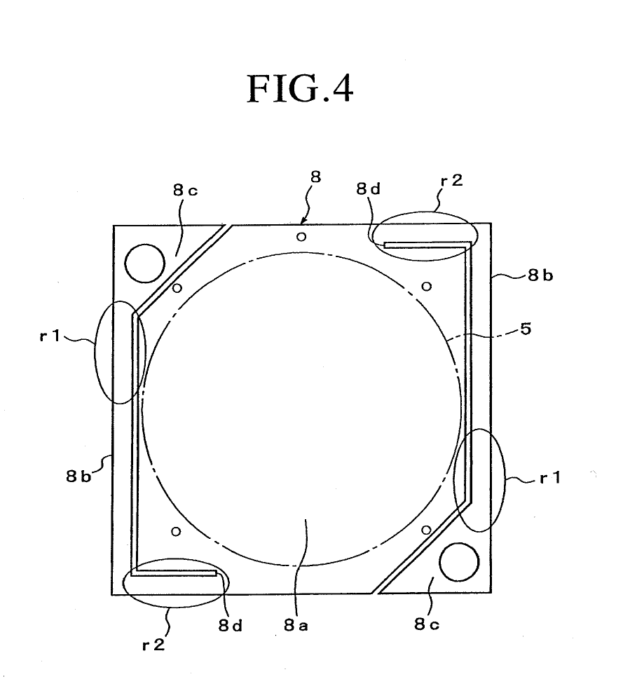

Further, in this embodiment, the arm sections 8b and 8b are formed in the square separator 8 so that the proximal portion 8d of the arm section 8b is located at diagonal position of the distal end 8c of the arm section 8b, and it is possible to obtain the arm section 8b length of a suitable length which is larger than that of the conventional separator shown in FIG. 4. Thus, local deformation of the arm section 8b under load can be reduced, and the deformation of the arm section 8b can be kept in the range of elastic deformation. In this way, since the deformation of the arm section 8b can be kept in the range of elastic deformation under load at high temperature, undesirable stress, which occurs on the power generation cells 5 when the arm sections 8b are plastically deformed, can be prevented from occurring, in the shrinking process of the whole fuel cell stack during falling temperature and, accordingly damage to the power generation cell 5 can be prevented.

In addition, since the proximal portion 8d and the distal end 8c of the arm section 8b are located at diagonally opposite corners of the square separator 8, distance “D” between a portion at which the power generation cell 5 is located and the proximal portion 8d of the arm section 8b can be increased as much as possible. Therefore, the effect of the deformation force of the arm sections 8b on the interconnect section 8a through the proximal portion 8d can be minimized, and deformation of the interconnect section 8a can be prevented, and flatness of the interconnect section 8a can be maintained. As a result, uneven load applied to the power generation cell 5 can be prevented, and damage to the power generation cell 5 can be prevented.

Further, since the corners of the arm sections 8b are rounded to eliminate structural discontinuity (namely, dicontinuous corners), concentration of stress at the corners of the arm sections 8b can be reduced, and local plastic deformation of the arm sections 8b can be suppressed. Accordingly, the deformation of the arm section 8b can be kept in the range of elastic deformation, and damage to the power generation cell 5 can be prevented.

### INDUSTRIAL APPLICABILITY

As described above, according to the present invention, it becomes possible to prevent plastic deformation of separators in a heat cycle of the fuel cell, to thereby prevent damage to the power generation cell.

1. A plate-laminated type fuel cell comprising:
a laminated body constructed by alternately laminating power generation cells and separators, each separator having a reactant gas passage inside thereof; and
a fuel gas manifold and an oxidant gas manifold located at a periphery of the laminated body, each manifold being in communication with the reactant gas passage of each separator and extending in the laminating direction,
wherein a load is applied to the laminated body in the laminating direction,
each of the separators including:
an interconnect section at a center of which the power generation cell is located; and
a pair of arm sections with an elongated strip shape, each arm section extending from a rim of the interconnect section, and an end of each arm section being connected to the fuel gas manifold or the oxidant gas manifold,
wherein each arm section has flexibility so that it can be deformed in the laminating direction, and the deformation of the arm section is kept in the range of elastic deformation during a heat cycle from startup to shutdown through power generating operation.

2. The flat plate laminated type fuel cell according to claim 1, wherein the fuel and oxidant gas manifolds are located at opposite corners of the laminated body having square column shape, and each arm section has a proximal portion extending from the interconnect section, and the proximal portion is located at diagonal position of a distal end of the corresponding arm section.

3. The flat plate laminated type fuel cell according to claim 2, wherein corners of the arm sections are made round.
